(19) United States
(12) Patent Application Publication
(10) Pub. No.: US 2006/0116353 A1
(43) Pub. Date: Jun. 1, 2006

(54) Method for removal of unwanted organism from the human body and a treatment for removal of unwanted organism from the human body

(76) Inventor: Arthur Vanmoor, Boca Raton, FL (US)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/287,700

(22) Filed: Nov. 28, 2005

Related U.S. Application Data
(60) Provisional application No. 60/631,249, filed on Nov. 26, 2004.

(51) Int. Cl. A01N 65/00; A01N 53/00; A01N 43/30

(52) U.S. Cl. 514/65; 514/464; 514/531

(57) ABSTRACT

A method and treatment for removing an unwanted living organism from a person includes administering topically to the person an effective amount of a solution including a pyrethrin compound and piperonyl butoxide. The term “pyrethrin compound” includes pyrethrin, cinerin, and allethrin. A carrier formulation can be added to said piperonyl butoxide and said pyrethrin compound to form a cream, an emulsion, a lotion, an ointment, or a paste. The carrier formulation can be based on petrolatum, mineral oil, vegetable oil, denatured ethanol, or isopropyl alcohol. The method and treatment can be applied for treating cuts and bruises, reducing body odor, repelling insects, and diminishing parasites.

### CROSS REFERENCE TO RELATED APPLICATION

This application claims the benefit of U.S. Provisional Application No. 60/631,249, filed Nov. 26, 2004.

### BACKGROUND OF THE INVENTION

1. Field of the Invention

The invention relates to a method for treating a person suffering damage or discomfort from the presence on or within the body of unwanted living organisms larger than bacteria with an agent effective in helping the affected person to reduce or eliminate the presence of such organisms and minimize associated pain and discomfort. Such organisms include, for example, amoebae, bedbugs, body lice, ear mites, flatworms, fleas, hair lice, head lice, nematodes, pinworms, roundworms, scabies, scorpions, sea lice, segmented worms, crabs (i.e. public lice), and others.

2. Description of the Related Art

A host of substances has been tried in the ongoing effort to cope with effects caused by the presence of unwanted organisms, such as those mentioned above, on or within the human body. Many of these substances have turned out to be too toxic to be used at all, or at least to require controlled use under medical supervision. A need continues to exist for effective treatments that laypersons can administer themselves, i.e. over the counter.

However, the scientific search for such better remedies is enormously costly. For economic reasons, the search tends to be skewed in the direction of finding novel remedies proprietary to their discoverers and owners. Novel remedies, of course, come into being with nothing known about either their safety or either effectiveness, so that both of these essential attributes need to be exhaustively studied before they can be used as intended.

The human body is enormously resilient. From the detoxification of foreign ingested chemicals in the liver to the proliferation of white blood corpuscles (also called leukocytes, or pus when seen to exude from the body) that can neutralize infectious agents, the body's resources are manifold and still insufficiently understood and utilized in deliberate and targeted ways.

To date, the art has tended to neglect the exploration of therapeutic properties of known substances that humans have been safely exposed to for untold generations. Along these lines, the present inventor has been able to bring about in susceptive individuals within a limited and reproducible time the appearance of headache, elevated blood pressure, facial pimples, signs of the so-called common cold, and pains in a joint by administering selected foods, food ingredients, and relatively harmless household chemicals as trigger substances, and to use these as research tools to study the effectiveness of certain nutrient substances in relieving these artificially produced conditions as well as their natural counterparts. As a result, certain water soluble amino carboxylic acid compounds are disclosed in U.S. Pat. Nos. 5,626,831, 5,707,967, 5,708,029, and 5,767,157 (all of these patents share an identical inventor as the instant application) as effective against facial pimples, the common cold, headaches, elevated blood pressure, and pain in a joint.

U.S. Pat. No. 6,479,547, which has an identical inventor as the instant application, discloses treating an infection with an aliphatic sulfur compound.

Piperonyl butoxide, also known as butylcarbityl 6-propylpiperonyl ether, is a known product of the perfume industry. The chemical formula of piperonyl butoxide is C₁₉H₃₀O₅. Alternate names for piperonyl butoxide include 1,3-Benzodioxole, 5-[[2-(2-butoxyethoxy)ethoxy]methyl]-6-propyl-; Toluene, α-[2-(2-butoxyethoxy)ethoxy]-4,5-(methylenedioxy)-2-propyl-; Butacide; Butocide; Butyl carbitol 6-propylpiperonyl ether; ENT 14,250; Pyrenone 606; 6-Propylpiperonyl butyl diethylene glycol ether; α-(2-(2-n-Butoxyethoxy)-ethoxy)-4,5-methylenedioxy-2-propyltoluene; α(2-(2-Butoxyethoxy)ethoxy)-4,5-methylenedioxy-2-propyltoluene; (3,4-Methylenedioxy-6-propylbenzyl) (butyl) diethylene glicol ether; Butylcarbityl (6-propylpiperonyl) ether; Ethanol butoxide; FMC 5273; NCI-C02813; NIA 5273; PB; 3,4-Methylendioxy-6-propylbenzyl-n-butyl-diaethylenglykolaether; 3,4-Methylenedioxy-6-propylbenzyl n-butyl diethyleneglycol ether; 5-((2-(2-Butoxyethoxy)ethoxy)methyl)-6-propyl-1,3-benzodioxole; 5-Propyl-4-(2,5,8-trioxa-dodecyl)-1,3-benzodioxol; 6-(Propylpiperonyl)butylcarbityl ether; Butoxide; FAC 5273; Nusyn-noxfish; Prentox; Pybuthrin; Pyrenon; Synpren-fish. FIG. 1 is a structural formula representing piperonyl butoxide.

Pyrethrin is an extract of pyrethrum flowers that has been used, suitably diluted with kerosene, as a knockdown spray insecticide against flying insects. It is described as containing either or both of viscous oxides represented by formulas C₂₁H₂₈O₃ and C₂₂H₂₈O₅. FIG. 2 is a structural formula depicting pyrethrin I. The closely related insecticidal substance cinerin is described as containing either or both the viscous oxides represented by the formulas C₂₀H₂₈O₃ and C₂₁H₂₈O₅. FIGS. 3-4 are structural formulas showing cinerin I and cinerin II, respectively. Allethrin is the name give to a compound with pyrethrin-like effectiveness synthesized by U.S. Department of Agriculture scientists. FIG. 5 is a structural formula depicting allethrin. The term “pyrethrin compound” is used in the application to refer to all member of the family of compounds encompassing pyrethrin, cinerin, and allethrin.

### SUMMARY OF THE INVENTION

It is accordingly an object of the invention to provide a method and treatment for removing an unwanted living organism from a person that overcomes the above-mentioned disadvantages of the heretofore-known compositions and methods of this general type.

With the foregoing and other objects in view there is provided, in accordance with the invention, a method that includes administering topically to the person an effective amount of a solution including a pyrethrin compound and piperonyl butoxide. The solution can be formed by using an oil-soluble solvent. Effective amounts of active ingredients include at least 0.1 mg of piperonyl butoxide and at least 0.1 mg of the pyrethrin compound.

In accordance with a further object of the invention, the formulation can include a carrier formulation. The carrier formulation can take the form of a cream, an emulsion, a lotion, an ointment, or a paste. Possible carrier formulations include petrolatum, mineral oil, vegetable oil, denatured ethanol, and isopropyl alcohol.

In accordance with a further object of the invention, the active ingredients (i.e. the piperonyl butoxide and pyrethrin compounds) are admixed in a ratio from 5 to 95 parts by weight of the piperonyl butoxide with from 5 to 95 parts by weight of the pyrethrin compound.

As stated, the term pyrethrin compound is meant to include pyrethrin, cinerin, and allethrin.

In accordance with a further object of the invention, a topical treatment for removing an unwanted living organism from a person is taught. The treatment includes an effective amount of a pyrethrin compound and piperonyl butoxide. The treatment can take the form of a cream an emulsion, a lotion, an ointment, or a paste. The treatment can be used for treating cuts and bruises, reducing body odor, repelling insects, and diminishing parasites attached to human hair follicles.

In accordance with this invention, there is provided a method of removing an unwanted living organism from a person in need thereof. The method includes the topical administration to such person of an effective amount of an oil-soluble admixture of a pyrethrin compound and piperonyl butoxide. Modest amounts, only, of the effective ingredients are required, as little as one tenth of a milligram (0.1 mg) each of piperonyl butoxide and pyrethrin compounds, so that it is convenient to present these effective amounts in any of a variety of carrier formulations including creams, emulsions, lotions, ointments, pastes, and solutions. Any carrier that can be safely applied to human skin can be used, including petrolatum, mineral oil, vegetable oils, and rubbing alcohol (suitably denatured ethanol or isopropyl alcohol).

In topically administering an admixture of piperonyl butoxide and a pyrethrin compound according to the invention, the relative proportions of these can range from five (5) parts by weight of piperonyl butoxide with ninety-five (95) parts by weight of a pyrethrin compound to ninety-five (95) parts by weight of piperonyl butoxide with five (5) parts by weight of pyrethrin compound an include all relative proportions within this range.

Thus, it has been found in accordance with this invention that topical treatment with piperonyl butoxide and pyrethrin compound can hasten the healing of cuts and bruises in human skin.

It has also been found in accordance with this invention that topical treatment with piperonyl butoxide and pyrethrin compound can diminish or eliminate body odors.

It has been found in accordance with this invention that topical treatment with piperonyl butoxide and pyrethrin compound can diminish or eliminate crawling insects that affect military personnel in the field.

It has furthermore been found in accordance with this invention that topical treatment with piperonyl butoxide and pyrethrin compound can diminish or eliminate parasites that lodge at the base of human hair follicles.

Other features which are considered as characteristic for the invention are set forth in the appended claims.

Although the invention is illustrated and described herein as embodied in a method for removal of unwanted organism from the human body and a treatment for removal of unwanted organism from the human body, it is nevertheless not intended to be limited to the details shown, since various modifications and structural changes may be made therein without departing from the spirit of the invention and within the scope and range of equivalents of the claims.

The formulation and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a structural formula representing the chemical formula for piperonyl butoxide.

FIG. 2 is a structural formula representing pyrethrin I.

FIG. 3 is a structural formula representing cinerin I.

FIG. 4 is a structural formula representing cinerin II.

FIG. 5 is a structural formula representing allethrin.

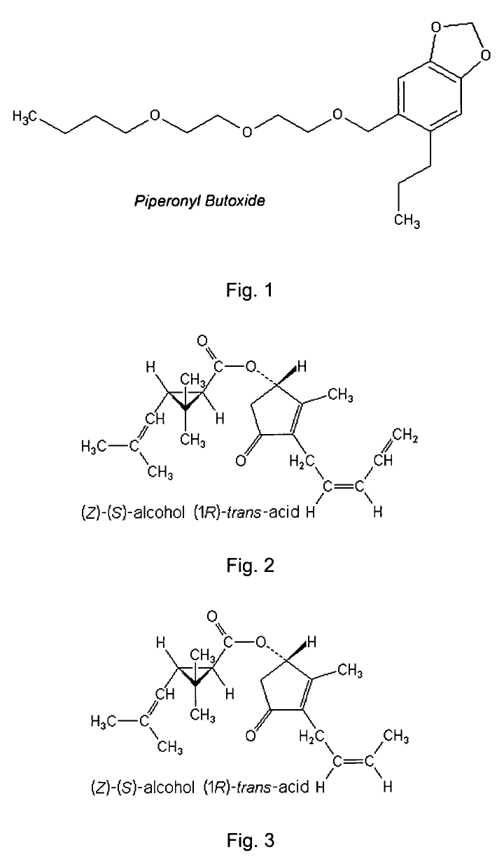

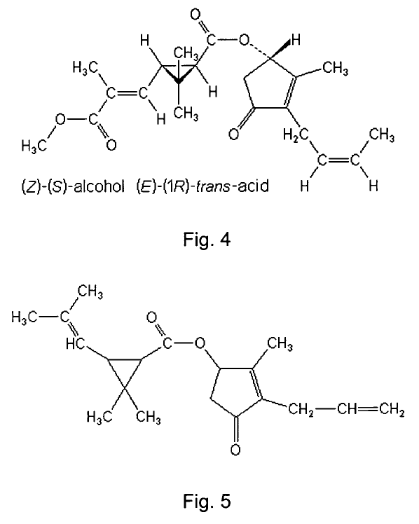

### DESCRIPTION OF THE PREFERRED EMBODIMENTS

The following examples were found to be efficacious.

### Example 1

An active ingredient is formed by combining five grams (5 g) of piperonyl butoxide with ninety-five grams (95 g) of pyrethrin.

Two grams (2 g) of the active ingredient was admixed with petrolatum to form one thousand (1000 g) of an ointment.

One gram (1 g) of the ointment was applied to a test subject's underarm. Subsequently, the test subject's treated underarm had fewer odors than the untreated underarm.

### Example 2

An active ingredient is formed by combining ninety-five grams (95 g) of piperonyl butoxide with five grams (5 g) of allethrin.

Two grams (2 g) of the active ingredient was admixed with mineral oil to form one thousand grams (1000 g) of an ointment.

One gram (1 g) of the ointment was applied to an area of scalp that was infected with a given number of head lice per that area. Afterward, the given number of head lice had been reduced.

### Example 3

An active ingredient is formed by combining fifty grams (50 g) of piperonyl butoxide with fifty grams (50 g) of cinerin.

Two grams (2 g) of the active ingredient was admixed with vegetable oil to form ten thousand grams (10,000 g) of an ointment.

A wound was made in a test subject. One gram (1 g) of the ointment was applied to half of the wound; the other half of the wound was untreated. The treatment was repeated three times daily. After one week, treated area had healed more than the untreated area. Afterward, the given number of head lice had been reduced.

I claim:

1. A method for removing an unwanted living organism from a person, which comprises administering topically to the person an effective amount of a solution including a pyrethrin compound and piperonyl butoxide.

2. The method according to claim 1, which further comprises using an oil-soluble solvent to form said solution.

3. The method according to claim 1, which further comprises:
including at least 0.1 mg of said piperonyl butoxide in said effective amount; and
including at least 0.1 mg of said pyrethrin compound in said effective amount.

4. The method according to claim 1, which further comprises forming said solution by adding a carrier formulation to said piperonyl butoxide and said pyrethrin compound.

5. The method according to claim 4, wherein said carrier formulation has a form selected from the group consisting of a cream, an emulsion, a lotion, an ointment, and a paste.

6. The method according to claim 4, which further comprises selecting said carrier formulation from the group consisting of petrolatum, mineral oil, vegetable oil, denatured ethanol, and isopropyl alcohol.

7. The method according to claim 1, which further comprises admixing from 5 to 95 parts by weight of said piperonyl butoxide with from 5 to 95 parts by weight of said pyrethrin compound.

8. The method according to claim 1, which further comprises selecting the pyrethrin compound from the group consisting of pyrethrin, cinerin, and allethrin.

9. A topical treatment for removing an unwanted living organism from a person, comprising an effective amount of a pyrethrin compound and piperonyl butoxide.

10. The topical treatment according to claim 9, further comprising an oil-soluble solvent dissolving said pyrethrin compound and piperonyl butoxide.

11. The topical treatment according to claim 9, wherein said effective amount includes at least 0.1 mg of said piperonyl butoxide and at least 0.1 mg of said pyrethrin compound.

12. The topical treatment according to claim 9, further comprising a carrier formulation selected from the group consisting of petrolatum, mineral oil, vegetable oil, denatured ethanol, and isopropyl alcohol.

13. The topical treatment according to claim 9, including from 5 to 95 parts by weight of said piperonyl butoxide admixed with from 5 to 95 parts by weight of said pyrethrin compound.

14. The topical treatment according to claim 9, wherein said pyrethrin compound is selected from the group consisting of pyrethrin, cinerin, and allethrin.

15. A cream for removing an unwanted living organism from a person, comprising the topical treatment according to claim 9.

16. An emulsion for removing an unwanted living organism from a person, comprising the topical treatment according to claim 9.

17. A lotion for removing an unwanted living organism from a person, comprising the topical treatment according to claim 9.

18. An ointment for removing an unwanted living organism from a person, comprising the topical treatment according to claim 9.

19. A paste for removing an unwanted living organism from a person, comprising the topical treatment according to claim 9.

20. A method for treating cuts and bruises, which comprises administering topically the topical treatment according to claim 9 to cuts and bruises.

21. A method for reducing body odor, which comprises administering topically the topical treatment according to claim 9 to an underarm of a subject.

22. A method for repelling insects, which comprises administering topically the topical treatment according to claim 9.

23. A method for diminishing parasites attached to human hair follicles, which comprises administering topically the topical treatment according to claim 9 to a base of an infected hair follicle.
